(19) United States
(12) Patent Application Publication
(10) Pub. No.: US 2025/0103662 A1
(43) Pub. Date: Mar. 27, 2025

(54) UNIFYING TRANSFORMERS WITH LINK BASED RANKING

(71) Applicant: Google LLC, Mountain View, CA (US)

(72) Inventor: Antonino Gulli, Paradiso (CH)

(73) Assignee: Google LLC, Mountain View, CA (US)

(21) Appl. No.: 18/471,793

(22) Filed: Sep. 21, 2023

(51) Int. Cl. G06F 16/9535; G06F 16/951

(52) U.S. Cl. CPC G06F 16/9535; G06F 16/951

(57) ABSTRACT

A method for unifying transformers with document signals includes obtaining a training sequence of tokens from a web page. The training sequence of tokens may represent text and the web page is associated with one or more web page signals. Each web page signal includes information relevant to the entire training sequence of tokens. The method includes determining, using the training sequence of tokens, an attention matrix. The attention matrix includes a plurality of weights and the plurality of weights direct focus of a machine learning model on inputs provided to the machine learning model. The method includes adjusting the attention matrix using the one or more web page signals and providing, to the machine learning model, an inference sequence of tokens. The method includes generating, by the machine learning model, a prediction based on the inference sequence of tokens and the adjusted attention matrix.

### TECHNICAL FIELD

This disclosure relates to unifying transformers with link based ranking.

### BACKGROUND

Currently, transformers are the key technology used in large language models (LMMs). One of the core concepts of transformers involves building an attention mechanism that allows the large model to focus on different parts of the input sequence. This is typically accomplished by computing a weighted sum of the input features, where the weights are determined by how relevant each feature is to the task at hand. The attention weights are generally determined using a query vector, a keys vector, and/or a values vector. The keys vector and values vector are usually the same input sequence, but they may be different sequences. The attention mechanism in transformers is often implemented using a scaled dot product attention mechanism. For example, the attention weights are computed as a dot product between the query vector and the keys vector. Typically, attention weights are calculated between every token in a sentence using three weight matrices: the query weights, the key weights, and the value weights.

### SUMMARY

One aspect of the disclosure provides a computer-implemented method for unifying transformers with document signal (e.g., link based) ranking. The method, when executed by data processing hardware, causes the data processing hardware to perform operations. The operations include obtaining a training sequence of tokens from a web page or other document. The training sequence of tokens may represent text and the web page is associated with one or more web page signals. Each web page signal of the one or more web page signals includes information relevant to the entire training sequence of tokens. The operations include determining, using the training sequence of tokens, an attention matrix. The attention matrix includes a plurality of weights and the plurality of weights direct focus of a machine learning model on inputs provided to the machine learning model. The operations include adjusting the attention matrix using the one or more web page signals and providing, to the machine learning model, an inference sequence of tokens. The operations include generating, by the machine learning model, a prediction based on the inference sequence of tokens and the adjusted attention matrix.

Implementations of the disclosure may include one or more of the following optional features. In some implementations, the one or more web page signals include one or more of an author of the web page, a ranking of the web page, traffic statistics of the web page, a creation date of the web page, a modification date of the web page, or an interaction metric of the web page. Determining the attention matrix may include determining a query weight matrix, determining a key weight matrix, and determining a value weight matrix. In some of these examples, determining the attention matrix further includes determining a dot product using the query weight matrix and the key weight matrix.

In some implementations, adjusting the attention matrix includes determining, using the one or more web page signals, that the web page satisfies a relevancy threshold and, in response to determining that the web page satisfies the relevancy threshold, increasing weights of the plurality of weights associated with the web page. In some examples, adjusting the attention matrix includes determining, using the one or more web page signals, that the web page fails to satisfy a relevancy threshold; and, in response to determining that the web page fails to satisfy the relevancy threshold, decreasing weights of the plurality of weights associated with the web page.

Optionally, the one or more web page signals include one or more static ranking signals of the web page. The machine learning model may include an attention mechanism. The machine learning model may include a self-attention mechanism. In some examples, adjusting the attention matrix occurs during training of the machine learning model.

Another aspect of the disclosure provides a system for unifying transformers with document signal (e.g., link based) ranking. The system includes data processing hardware and memory hardware in communication with the data processing hardware. The memory hardware stores instructions that when executed on the data processing hardware cause the data processing hardware to perform operations. The operations include obtaining a training sequence of tokens from a web page or other document. The training sequence of tokens may represent text and the web page is associated with one or more web page signals. Each web page signal of the one or more web page signals includes information relevant to the entire training sequence of tokens. The operations include determining, using the training sequence of tokens, an attention matrix. The attention matrix includes a plurality of weights and the plurality of weights direct focus of a machine learning model on inputs provided to the machine learning model. The operations include adjusting the attention matrix using the one or more web page signals and providing, to the machine learning model, an inference sequence of tokens. The operations include generating, by the machine learning model, a prediction based on the inference sequence of tokens and the adjusted attention matrix.

This aspect may include one or more of the following optional features. In some implementations, the one or more web page signals include one or more of an author of the web page, a ranking of the web page, traffic statistics of the web page, a creation date of the web page, a modification date of the web page, or an interaction metric of the web page. Determining the attention matrix may include determining a query weight matrix, determining a key weight matrix, and determining a value weight matrix. In some of these examples, determining the attention matrix further includes determining a dot product using the query weight matrix and the key weight matrix.

In some implementations, adjusting the attention matrix includes determining, using the one or more web page signals, that the web page satisfies a relevancy threshold and, in response to determining that the web page satisfies the relevancy threshold, increasing weights of the plurality of weights associated with the web page. In some examples, adjusting the attention matrix includes determining, using the one or more web page signals, that the web page fails to satisfy a relevancy threshold; and, in response to determining that the web page fails to satisfy the relevancy threshold, decreasing weights of the plurality of weights associated with the web page.

Optionally, the one or more web page signals include one or more static ranking signals of the web page. The machine learning model may include an attention mechanism. The machine learning model may include a self-attention mechanism. In some examples, adjusting the attention matrix occurs during training of the machine learning model.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for unifying transformers with document signal ranking.

FIG. 2 is a flowchart of an example arrangement of operations for a method of unifying transformers with document signal ranking.

FIG. 3 is a schematic view of an example computing device that may be used to implement the systems and methods described herein.

Like reference symbols in the various drawings indicate like elements.

### DETAILED DESCRIPTION

Currently, transformers are the key technology used in large language models (LMMs). One of the core concepts of transformers involves building an attention mechanism that allows the large model to focus on different parts of the input sequence. This is typically accomplished by computing a weighted sum of the input features, where the weights are determined by how relevant each feature is to the task at hand. The attention weights are generally determined using a query vector, a keys vector, and/or a values vector. The keys vector and values vector are usually the same input sequence, but they may be different sequences. The attention mechanism in transformers is often implemented using a scaled dot product attention mechanism. For example, the attention weights are computed as a dot product between the query vector and the keys vector. Typically, attention weights are calculated between every token in a sentence using three weight matrices: the query weights, the key weights, and the value weights.

However, conventional attention is only based on sequences of tokens (e.g., words) and does not take into account documents or any other information pertaining to the object containing the sequence. For example, when the sequence is contained in a web page, conventional transformers only focus on the different tokens contained in the web page but not on the importance of the web page itself. Taking into account per-document signals in addition to per-token signals can help increase the focus on relevant parts of the input sequence. At training time, crucially, two tokens in an input sequence are more relevant when the tokens belong to a relevant document (e.g., web page). At inference time, this in turn reduces the risk of the model generating hallucinations while also increasing grounding, which is a critical generative artificial intelligence goal.

In other examples, when the input sequence is contained in an image, conventional transformers only focus on the different tokens contained in the image and not on the importance of the image itself. Taking into account per-image signals in addition to per-token signals can help increase the focus on relevant parts of the input sequence. Similarly, at training time, two tokens in an input sequence are more relevant when the two tokens belong to a relevant image. At inference time, this increases the quality of the generations because the generations are based on additional information incorporating metrics of importance of the images.

In yet other examples, the input sequence is contained in other types of modalities such as text documents, audio files, video files, DNA sequences, natural language, vision, protein modeling, music, robotics, etc.

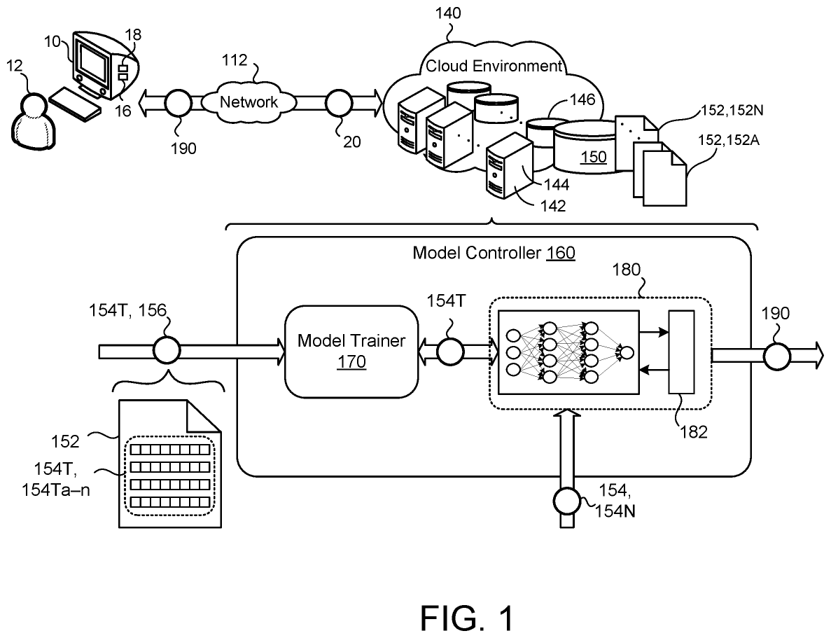

Referring to FIG. 1, in some implementations, an example model generation system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 150 (i.e., a remote storage device) may be overlain on the storage resources 146 to allow scalable use of the storage resources 146 by one or more of the clients (e.g., the user device 10) or the computing resources 144. The data store 150 is configured to store a set of documents 152, 152a-n. The documents 152 may be of any type and from any source (e.g., from the user 12, other remote entities, or generated by the remote system 140). As used herein, document refers to any container of information, such as text documents, web pages, images, video files, audio files, and any combination thereof.

The remote system 140 is configured to receive a model generation request 20 (e.g., from a user device 10 associated with a respective user 12 via, for example, the network 112). The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware). The request 20 may include one or more documents 152 for model training. Additionally or alternatively, the request 20 may refer to one or more documents 152 stored at the data store 150 and/or at other remote entities for training.

The remote system 140 executes a model controller 160. The model controller 160 includes a model trainer 170. The model trainer 170 receives or obtains (e.g., from the user device 10, from the data store 150, via the Internet, etc.) a training sequence of tokens 154, 154T, 154Ta-n from a document 152. The sequence of training tokens 154T are a result of tokenization of the document 152, which is a method of breaking the information of the document 152 down into smaller pieces. For example, when the document 152 is a web page, each token 154T of the training sequence of tokens 154T represents part or all of one or more words of the web page. As another example, when the document 152 is an image, each token 154T of the training sequence of tokens 154T represents one or more pixels of the image. The tokens 154T may be embedded into an embedding.

The model trainer 170 also obtains or receives one or more document signals 156 that each include information relevant to the document 152 (i.e., the entire training sequence of tokens 154T). For example, when the document 152 is a web page, the documents signals 156 are web page signals that include information relevant to the web page and to the entirety of the training sequence of tokens 154T (i.e., not just a single token 154T or subset of tokens 154T). Put another way, the document signals 156 represent per-document signals instead of per-token signals. For instance, when the document 152 is a web page, the web page signals may include an author of the web page, a ranking of the web page, traffic statistics of the web page (e.g., a number of users who have visited the web page in a period of time, how long users visit the web page, etc.), a creation date of the web page, a modification data of the web page (i.e., when the web page was last modified or updated), and/or an interaction metric of the web page (e.g., how frequently users interact with the web page via clicking links or other selections within the web page).

The model trainer 170 determines and/or updates, using the training sequence of tokens 154T, an attention matrix 182 of a machine learning model 180. The attention matrix 182 includes a plurality of weights that direct focus of the machine learning model 180 on inputs provided to the machine learning model. That is, the attention matrix 182 is part of an attention mechanism of the machine learning model 180 that allows the machine learning model 180 to selectively focus on important input elements to improve prediction accuracy and computational efficiency (i.e., by prioritizing the most relevant information of the input).

The model trainer 170 may determine the attention matrix 182 and/or the attention mechanism while training the machine learning model 180 using any conventional techniques. For example, the model trainer 170 determines a query weight matrix, a key weight matrix, and a value weight matrix. Using this technique, the model trainer 170 may, during training, determine the attention matrix 182 based on a dot product using the weight matrices (e.g., a dot product using the query weight matrix and the key weight matrix). The machine learning model 180 may include an attention mechanism and/or a self-attention mechanism.

The model trainer 170 adjusts the attention matrix 182 using the one or more document signals 156. That is, the model trainer 170 adjusts the attention matrix 182 (i.e., boosts or reduces one or more weights of the attention matrix 182) based on the document signals 156 of the document 152 the training sequence of tokens 154T was derived from. That is, the model trainer 180 may increase the impact the training sequence of tokens 154T has on the attention matrix 182 than the training sequence of tokens 154T would otherwise have without consideration of the document signals 156 (i.e., using conventional attention mechanisms). The document signals 156 may be static ranking signals of the document 152. In one example, the document 152 is a web page, the document signals 156 include a page ranking of the web page, and the model trainer 170 adjusts the attention matrix 182 based on the page ranking of the web page. This allows the model trainer 170 to boost the weights associated with particularly relevant documents 152 (e.g., web pages with a very high page ranking, documents authored by a prominent author, etc.). For example, when the document signals 156 indicate that the document 152 was authored by a very prominent and respected author, the model trainer 170 increases the impact the training sequence of tokens 154T has on the attention matrix 182 relative to the amount of impact the training sequence of tokens 154T would have using conventional techniques. The model trainer 170 may adjust the attention matrix 182 in any number of weighs. For example, the model trainer 170 may use a linear combination or exponentials based on one or more parameters associated with the document signals 156.

In some implementations, the model trainer 180 determines, using the document signals 156, that the document 152 satisfies a relevancy threshold and, in response, increases weights of the attention matrix 182 associated with the document 152. Optionally, the model trainer 180 determines, using the document signals 156, that the document 152 fails to satisfy the relevancy threshold, and, in response, decreases or maintains weights of the attention matrix 182 associated with the document 152. The relevancy threshold may be configurable (e.g., by the user 12) or determined based on one or more parameters such as the documents 152, the training sequence of tokens 154T, an architecture of the machine learning model 180, etc.

The trained model 180 (i.e., the machine learning model 180 after the model trainer 170 completes training) may be stored at the remote system 140 (e.g., at the data store 150) and/or provided to one or more entities for use in generating predictions 190. For example, the model controller 160 provides the machine learning model 180 to the user device 10. In other examples, the model controller 160 receives requests to generate predictions 190 using the machine learning model 180.

In some implementations, after the model trainer 170 trains the machine learning model 180 using training sequence of tokens 154T from any number of documents 152 and adjusting the attention matrix 182 based on the document signals 156 from at least a portion of the documents 152 used to train the machine learning model 180, the trained model 180 may be used to generate one or more predictions 190. For example, an inference sequence of tokens 154, 154N is provided to the trained model 180 (e.g., from the user 12 or other entity) and, based on the inference sequence of tokens 154N and the adjusted attention matrix 182, the machine learning model 180 generates a prediction 190.

Thus, implementations herein include using document signals 156 (e.g., document static ranking signals) available for documents 152 in, for example, the Internet, by adjusting (e.g., boosting) the attention weights. Conventionally, attention weights are computed using the query and key vectors. For example, the attention weight a_{{ij}} from token i to token j is the dot product between q_{{i}} and k_{{j}}. In some implementations, the dot product is adjusted (e.g., increased) for documents 152 originating from highly link relevant documents 152. In some examples, the self-attention conventionally used for transformers is adjusted for highly link relevant documents, such as documents with high page ranking. That is, the importance of the document 152 (e.g., web page) may be expressed with many static ranking such as how many links points to the document 152, who is the author of the document 152, what is the page ranking of the document 152, how fresh is the document 152, how many interactions (e.g., page clicks) have occurred with the document 152, the traffic observed for the document 152, etc. All of these signals may be combined to adjust the focus on different parts of the input sequence to a machine learning model, according to the importance of the containing document.

In some implementations, static signals related to images are used to adjust the attention mechanism in transformers computed to focus on different parts of the input sequence contained in the image. In other implementations, static signals related respectively to text documents, PDFs, audio files, video files, DNA sequences, natural language, vision, protein modeling, music, robotics, etc., are used to adjust the attention mechanism in transformers computed to focus on different parts of the input sequence contained respectively in the input.

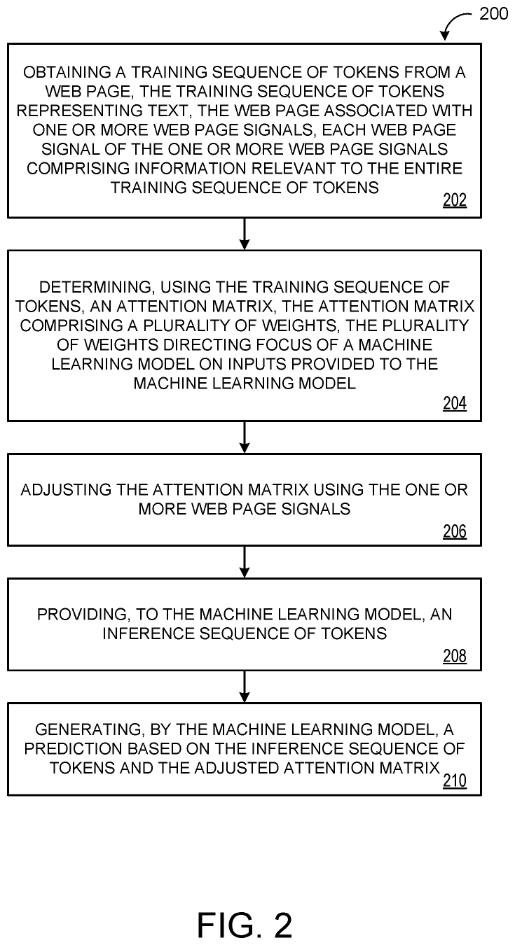

FIG. 2 is a flowchart of an exemplary arrangement of operations for a computer-implemented method 200 that, when executed by data processing hardware 144, causes the data processing hardware 144 to perform operations. The method 200 includes obtaining a training sequence of tokens 154T from a web page 152. The training sequence of tokens 154T represents text and the web page 152 is associated with one or more web page signals 156. Each web page signal 156 of the one or more web page signals 156 includes information relevant to the entire training sequence of tokens 154T. The method 200, at operation 204, includes determining, using the training sequence of tokens 154T, an attention matrix 182. The attention matrix 182 includes a plurality of weights and the plurality of weights direct focus of a machine learning model 180 on inputs provided to the machine learning model 180. At operation 206, the method 200 includes adjusting the attention matrix 182 using the one or more web page signals 156. At operation 208, the method includes providing, to the machine learning model 180, an inference sequence of tokens 154N. At operation 210, the method 200 includes generating, by the machine learning model 180, a prediction 190 based on the inference sequence of tokens 154N and the adjusted attention matrix 182.

In other methods, the training sequence of tokens 154T are from documents 152 in addition to or other than web pages, such as text documents, images, audio files, etc. In these other methods, the web page signals 156 are instead represented by other appropriate document signals 156 (such as image signals when the documents 152 are images).

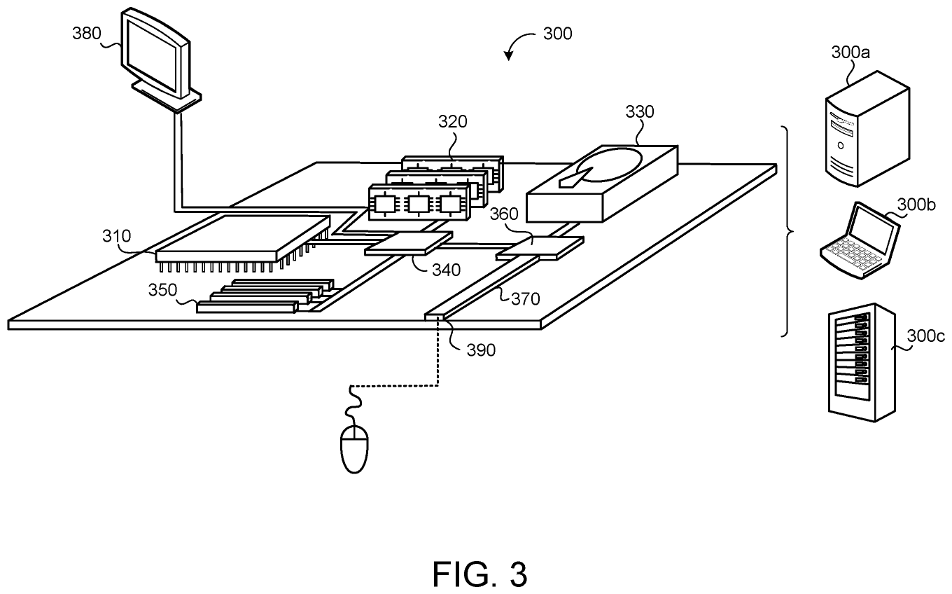

FIG. 3 is a schematic view of an example computing device 300 that may be used to implement the systems and methods described in this document. The computing device 300 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 300 includes a processor 310, memory 320, a storage device 330, a high-speed interface/controller 340 connecting to the memory 320 and high-speed expansion ports 350, and a low speed interface/controller 360 connecting to a low speed bus 370 and a storage device 330. Each of the components 310, 320, 330, 340, 350, and 360, are interconnected using various busses, and may be mounted on a common motherboard or in other manners as appropriate. The processor 310 can process instructions for execution within the computing device 300, including instructions stored in the memory 320 or on the storage device 330 to display graphical information for a graphical user interface (GUI) on an external input/output device, such as display 380 coupled to high speed interface 340. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 320 stores information non-transitorily within the computing device 300. The memory 320 may be a computer-readable medium, a volatile memory unit(s), or non-volatile memory unit(s). The non-transitory memory 320 may be physical devices used to store programs (e.g., sequences of instructions) or data (e.g., program state information) on a temporary or permanent basis for use by the computing device 300. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 330 is capable of providing mass storage for the computing device 300. In some implementations, the storage device 330 is a computer-readable medium. In various different implementations, the storage device 330 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 320, the storage device 330, or memory on processor 310.

The high speed controller 340 manages bandwidth-intensive operations for the computing device 300, while the low speed controller 360 manages lower bandwidth-intensive operations. Such allocation of duties is exemplary only. In some implementations, the high-speed controller 340 is coupled to the memory 320, the display 380 (e.g., through a graphics processor or accelerator), and to the high-speed expansion ports 350, which may accept various expansion cards (not shown). In some implementations, the low-speed controller 360 is coupled to the storage device 330 and a low-speed expansion port 390. The low-speed expansion port 390, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 300a or multiple times in a group of such servers 300a, as a laptop computer 300b, or as part of a rack server system 300c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
obtaining a training sequence of tokens from a web page, the training sequence of tokens representing text, the web page associated with one or more web page signals, each web page signal of the one or more web page signals comprising information relevant to the entire training sequence of tokens;
determining, using the training sequence of tokens, an attention matrix, the attention matrix comprising a plurality of weights, the plurality of weights directing focus of a machine learning model on inputs provided to the machine learning model;
adjusting the attention matrix using the one or more web page signals;
providing, to the machine learning model, an inference sequence of tokens; and
generating, by the machine learning model, a prediction based on the inference sequence of tokens and the adjusted attention matrix.

2. The method of claim 1, wherein the one or more web page signals comprise one or more of:
an author of the web page;
a ranking of the web page;
traffic statistics of the web page;
a creation date of the web page;
a modification date of the web page; or
an interaction metric of the web page.

3. The method of claim 1, wherein determining the attention matrix comprises:
determining a query weight matrix;
determining a key weight matrix; and
determining a value weight matrix.

4. The method of claim 3, wherein determining the attention matrix further comprises determining a dot product using the query weight matrix and the key weight matrix.

5. The method of claim 1, wherein adjusting the attention matrix comprises:
determining, using the one or more web page signals, that the web page satisfies a relevancy threshold; and
in response to determining that the web page satisfies the relevancy threshold, increasing weights of the plurality of weights associated with the web page.

6. The method of claim 1, wherein adjusting the attention matrix comprises:
determining, using the one or more web page signals, that the web page fails to satisfy a relevancy threshold; and
in response to determining that the web page fails to satisfy the relevancy threshold, decreasing weights of the plurality of weights associated with the web page.

7. The method of claim 1, wherein the one or more web page signals comprise one or more static ranking signals of the web page.

8. The method of claim 1, wherein the machine learning model comprises an attention mechanism.

9. The method of claim 1, wherein the machine learning model comprises a self-attention mechanism.

10. The method of claim 1, wherein adjusting the attention matrix occurs during training of the machine learning model.

11. A system comprising:
data processing hardware; and
memory hardware in communication with the data processing hardware, the memory hardware storing instructions that when executed on the data processing hardware cause the data processing hardware to perform operations comprising:
obtaining a training sequence of tokens from a web page, the training sequence of tokens representing text, the web page associated with one or more web page signals, each web page signal of the one or more web page signals comprising information relevant to the entire training sequence of tokens;
determining, using the training sequence of tokens, an attention matrix, the attention matrix comprising a plurality of weights, the plurality of weights directing focus of a machine learning model on inputs provided to the machine learning model;
adjusting the attention matrix using the one or more web page signals;
providing, to the machine learning model, an inference sequence of tokens; and
generating, by the machine learning model, a prediction based on the inference sequence of tokens and the adjusted attention matrix.

12. The system of claim 11, wherein the one or more web page signals comprise one or more of:
an author of the web page;
a ranking of the web page;
traffic statistics of the web page;
a creation date of the web page;
a modification date of the web page; or
an interaction metric of the web page.

13. The system of claim 11, wherein determining the attention matrix comprises:
determining a query weight matrix;
determining a key weight matrix; and
determining a value weight matrix.

14. The system of claim 13, wherein determining the attention matrix further comprises determining a dot product using the query weight matrix and the key weight matrix.

15. The system of claim 11, wherein adjusting the attention matrix comprises:
determining, using the one or more web page signals, that the web page satisfies a relevancy threshold; and
in response to determining that the web page satisfies the relevancy threshold, increasing weights of the plurality of weights associated with the web page.

16. The system of claim 11, wherein adjusting the attention matrix comprises:
determining, using the one or more web page signals, that the web page fails to satisfy a relevancy threshold; and
in response to determining that the web page fails to satisfy the relevancy threshold, decreasing weights of the plurality of weights associated with the web page.

17. The system of claim 11, wherein the one or more web page signals comprise one or more static ranking signals of the web page.

18. The system of claim 11, wherein the machine learning model comprises an attention mechanism.

19. The system of claim 11, wherein the machine learning model comprises a self-attention mechanism.

20. The system of claim 11, wherein adjusting the attention matrix occurs during training of the machine learning model.
